(19) United States
(12) Patent Application Publication
(10) Pub. No.: US 2020/0080913 A1
(43) Pub. Date: Mar. 12, 2020

(54) COMPACT LENS TESTER

(71) Applicant: Rockwell Automation Technologies, Inc., Mayfield Heights, OH (US)

(72) Inventor: Michael M. Tilleman, Brookline, MA (US)

(21) Appl. No.: 16/127,787

(22) Filed: Sep. 11, 2018

(51) Int. Cl. G01M 11/02; G02B 13/22

(52) U.S. Cl. CPC G01M 11/0264; G01M 11/0214; G01M 11/0292; G02B 13/22

(57) ABSTRACT

For lens testing, a telecentric lens aims light from a light source on an exit pupil formed relative to a device lens of a device-under-test. A sensor receives light from the device-under-test.

### BACKGROUND INFORMATION

The subject matter disclosed herein relates to a compact lens tester.

### BRIEF DESCRIPTION

An apparatus for lens testing is disclosed. The apparatus includes a light source, a telecentric lens, and a sensor. The telecentric lens aims light from the light source on an exit pupil formed relative to a device lens of a device-under-test. The sensor receives light from the device-under-test.

A system for lens testing is also disclosed. The system includes a light source, a telecentric lens, a sensor, and the dynamic fixture. The telecentric lens aims light from the light source on an exit pupil formed relative to a device lens of a device-under-test. The sensor receives light from the device-under-test. The dynamic fixture actively aligns at least one of the device-under-test and the sensor.

A method for lens testing is further disclosed. The method acquires pixel charge contents of an image pattern from a sensor that receives light from a device-under-test. The light is aimed from a light source on an exit pupil formed relative to a device lens of the device-under-test by a telecentric lens. The method further computes device-under-test characteristics from the pixel charge contents.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A shows a side view schematic diagram of a lens tester according to an embodiment;

FIG. 1B shows a side view schematic diagram of light paths through a lens tester according to an embodiment;

FIG. 1C is a side view schematic diagram of the lens tester with a dynamic fixture according to an embodiment;

FIG. 1D is a side view schematic diagram of the lens tester with dynamic fixtures according to an alternate embodiment;

FIG. 1E is a schematic diagram of a diffuser angle of expansion according to an embodiment;

FIG. 2A is a schematic diagram of the lens tester with a device-under-test according to an embodiment;

FIG. 2B shows a side view schematic diagram of light paths through a lens tester and a compound lens device-under-test;

FIG. 3A is a plot of a Modulus of Optical Transfer Function (MTF) vs. spatial frequency for a lens tester with device-under-test according to an embodiment;

FIG. 3B is a plot of MTF vs. field for a lens tester with device-under-test according to an embodiment;

FIG. 3C are plots of field curvature vs. field and distortion vs. field according to an embodiment;

FIG. 3D is a plot of relative illumination vs. field for a lens tester with device-under-test according to an embodiment;

FIG. 4A is a side view schematic diagram of the lens tester with a compact compound lens device-under-test according to an embodiment;

FIG. 4B shows a side view schematic diagram of light paths through a lens tester and a compound lens device-under-test according to an embodiment;

FIG. 5A is a plot of a MTF vs. spatial frequency for a lens tester with device-under-test according to an embodiment;

FIG. 5B is a plot of MTF vs. field for a lens tester with device-under-test according to an embodiment;

FIG. 5C are plots of field curvature vs. field and distortion vs. field according to an embodiment;

FIG. 5D is a plot of relative illumination vs. field for a lens tester with device-under-test according to an embodiment;

FIG. 6 is a drawing of a test pattern according to an embodiment;

FIG. 7A is a side view schematic diagram of a light source with beam homogenizer according to an embodiment;

FIG. 7B is a plot of irradiance versus lateral space of calculated profiles of a beam according to an embodiment;

FIG. 7C is a plot of a footprint of irradiance distribution of calculated profiles of a beam according to an embodiment;

FIG. 7D is a plot of light paths through a light source with beam homogenizer according to an embodiment;

FIG. 7E is a plot of a footprint of irradiance distribution of calculated profiles for a homogenized beam according to an embodiment;

FIG. 7F is a plot of footprints of irradiance distribution of calculated profiles for a beam and a homogenized beam according to an embodiment;

FIG. 7G is a side view schematic diagram of light paths through a light source with beam homogenizer;

FIG. 8A is a side view schematic diagram of a lens tester illuminated by a light source with a beam homogenizer according to an embodiment;

FIG. 8B shows a side view schematic diagram of light paths through a lens tester with beam homogenizer according to an embodiment;

FIG. 9A is a side view schematic of a lens tester without a test pattern according to an embodiment;

FIG. 9B is a side view schematic of light paths through a lens tester without a test pattern according to an embodiment;

FIG. 10 is a schematic block diagram of a computer according to an embodiment; and

FIG. 11 is a flow chart diagram of a method of computation of the device-under-test characteristics according to an embodiment.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

Optical devices, such as cameras, instruments, lenses, sensors, and combinations thereof are often tested to assure that the optical device performs as designed. Unfortunately, suitable testers can be bulky and/or expensive. The embodiments described herein employ a telecentric lens that aims light on an exit pupil disposed relative to a device lens of a device-under-test to reduce the size and cost of a lens tester. In addition, the embodiments may employ a sensor of the device-under-test to characterize the device lens and/or device-under-test. The embodiments are further scalable to support the testing of a wide variety of device lenses and/or optical devices as will be described hereafter.

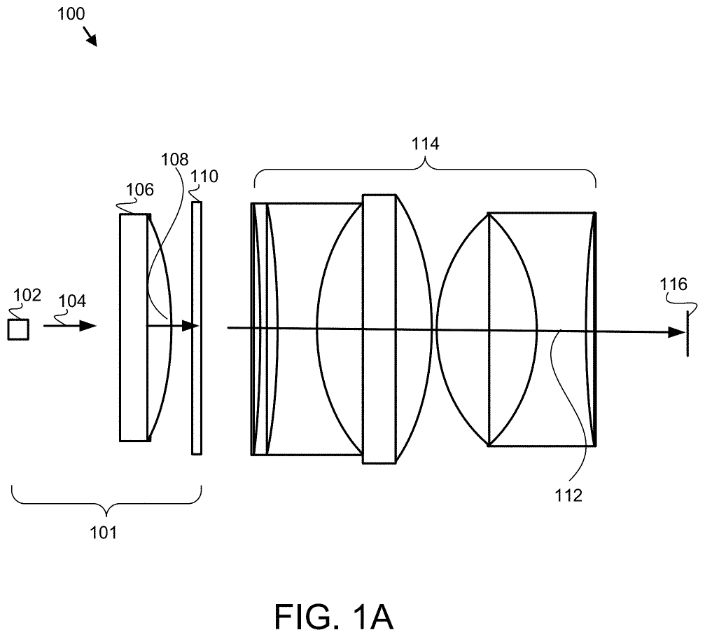

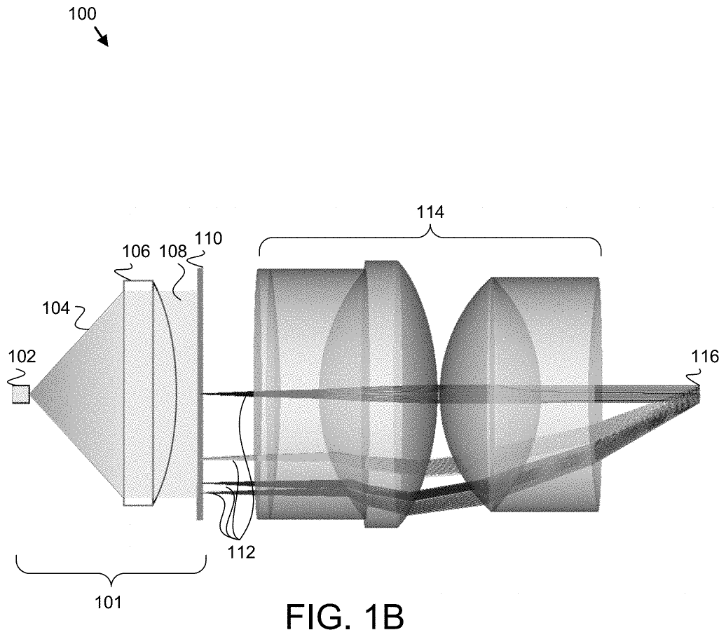

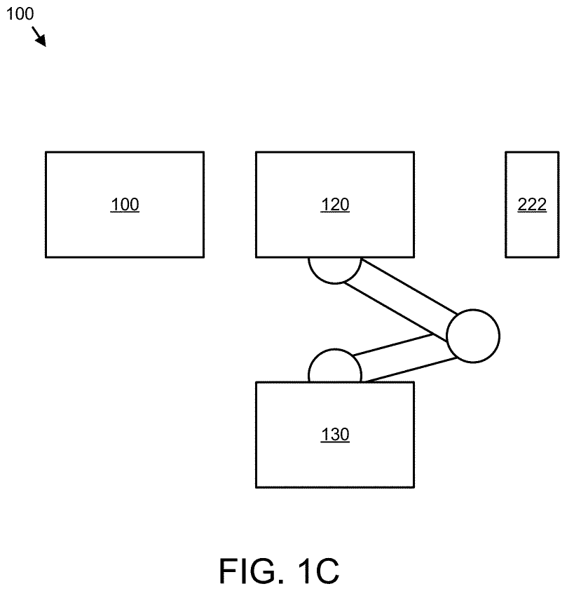

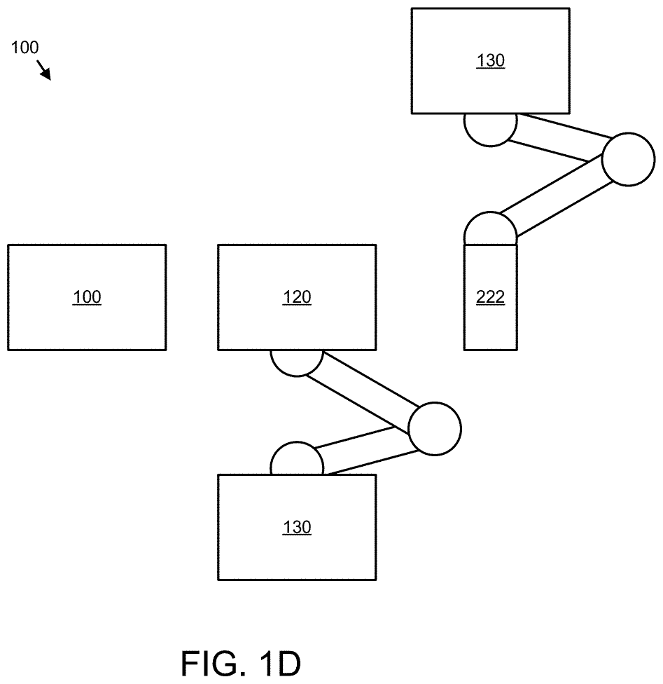

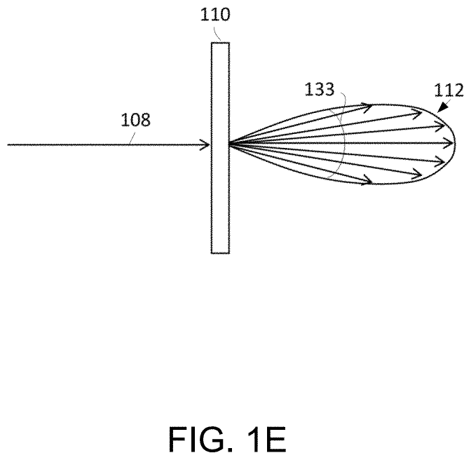

FIG. 1A is a schematic diagram of a lens tester 100 of the embodiments. In the depicted embodiment, the lens tester 100 includes a light source 101 comprising a source 102, a collimating lens 106, and a test pattern 110. In one embodiment, the test pattern 110 is an optical diffuser. The optical diffuser may have a diffuser angle of expansion of less than ±10 degrees relative to a beam 108. The source 102 may be selected from the group consisting of a point source 102, an extended source 102, and a plurality of sources 102. The light source 101 and/or source 102 may emit substantially polychromatic radiation or substantially monochromatic radiation. The light source 101 and/or source 102 may emit light in a specified frequency in the group consisting of 190-390 nanometers (nm), 390-780 nm, and above 780 nm.

The exiting beam from the collimating lens 106 is the beam 108, being incident on the test pattern 110. Then, ray bundles 112 carrying the object information from the test pattern 110 are refracted by the lens 114 that collimates them aiming them at the exit pupil 116. The lens tester 100 further includes a telecentric lens 114. The telecentric lens 114 may have a numerical aperture of not greater than 0.5. Alternatively, the telecentric lens 114 may have a numerical aperture of greater than 0.5. In one embodiment, the telecentric lens 114 is an eyepiece. An exit pupil 116 may be disposed relative to a device lens of a device-under-test. In one embodiment, the exit pupil 116 is disposed outside of the telecentric lens 114. Table 1 illustrates one embodiment of a prescription for a telecentric lens 114.

TABLE 1

| | Power | | Abbe | Thickness | Aperture |
|---|---|---|---|---|---|
| Element | (diopter) | Index | number | (mm) | (mm) |
| Diffuser | 0 | NA | NA | NA | 17.0 |
| Air gap | 0 | 1.0003 | NA | 3.768 | |
| Primary | −75.1665 | 1.63148 | 60.102 | 1.5 | 17.0 |
| Secondary | 45.02007 | 1.59099 | 38.03 | 2.64 | 19.4 |
| Air | | 1.0003 | | 3.57 | |
| Tertiary | 97.5723 | 1.99543 | 29.06 | 5.012 | 19.4 |
| Air | | 1.0003 | | 0.15 | |
| Quaternary | 129.0201 | 1.63148 | 60.102 | 6.875 | 16.0 |
| Quinary | −71.4844 | 1.68134 | 30.068 | 3.62 | 16.0 |
| Air | | 1.0003 | | 7.46 | |
| Stop | 0 | NA | NA | | 1.11 |

In one embodiment, a prescription for the telecentric lens 114 minimizes a merit function comprising a location of the exit pupil 116, ray height, a field-of-view, and/or a collimation of rays in ray bundles 112 for the device-under-test.

In one embodiment, the source 102 emits a light beam 104 which is collimated by the collimating lens 106. The exiting beam from the collimating lens 106 is the beam 108, and is incident on the test pattern 110. In one embodiment, the test pattern 110 comprises an optical diffuser. Ray bundles 112 carrying the object information from the test pattern 110 are refracted by the telecentric lens 114. The telecentric lens 114 collimates the ray bundles 112, aiming the ray bundles 112 at the exit pupil 116. Since the lens 114 is telecentric, the distance from the test pattern 110 has a very large tolerance without compromising lens tester performance. As a result, the lens tester 100 may be easily scaled to test a variety of optical devices and/or lenses. For descriptive purposes, light traversing the lens tester 100 may be referred to as the light beam 104, the beam 108, and the ray bundles 112.

FIG. 1B shows a side view schematic diagram of light paths 104/108/112 through a lens tester 100. Exemplary light paths of the light beam 104, the beam 108, and the ray bundles 112 are shown.

FIG. 1C is a side view schematic diagram of the lens tester 100 with a dynamic fixture 130. The dynamic fixture 130 may motivate the device-under-test 120 through one or more degrees of freedom. The dynamic fixture 130 may align the device-under-test 120 with the lens tester 100 and/or sensor 222. In one embodiment, the dynamic fixture 130 aligns the device-under-test 120 based on characteristics of ray bundles 112 received at the sensor 222.

FIG. 1D is a side view schematic diagram of the lens tester 100 with dynamic fixtures 130. In the depicted embodiment, a first dynamic fixture 130 aligns the device-under-test 120 and a second dynamic fixture 130 aligns the sensor 222.

FIG. 1E is a schematic diagram of an optical diffuser 110 and the manner by which the optical diffuser 110 diffuses the incident beam 108 into a diffused ray bundle 112 expanding with a diffuser angle of expansion 133.

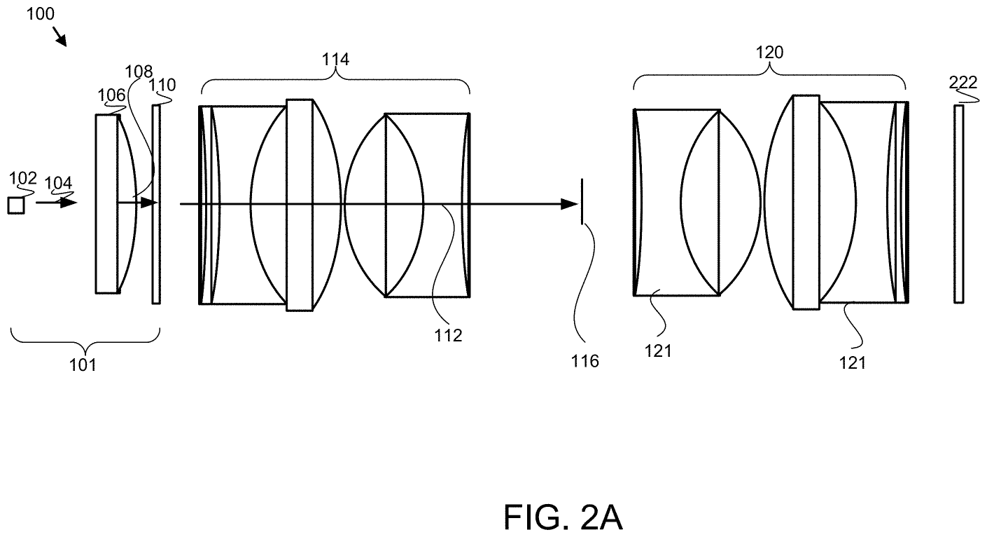

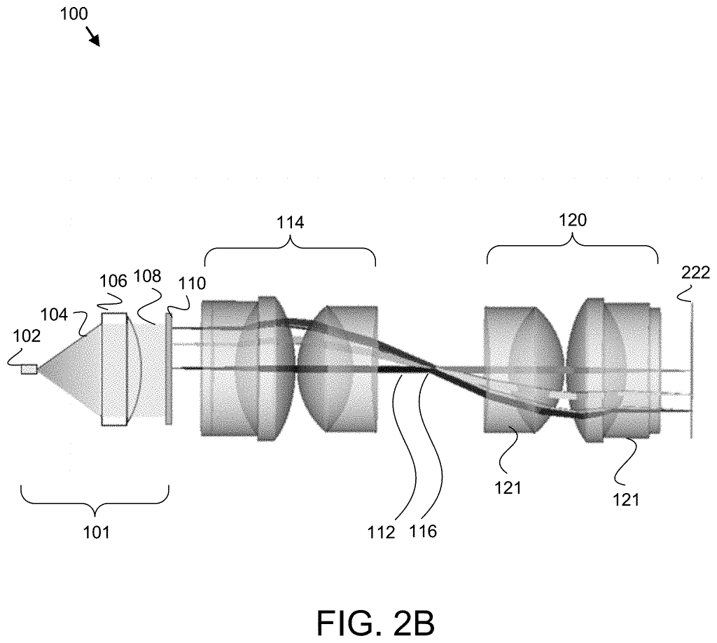

FIG. 2A is a schematic diagram of the lens tester 100 with a device-under-test 120. The device-under-test 120 may include one or more device lenses 121. In the depicted embodiment, the device-under-test 120 is the telecentric lens 114 rotated at 180 degrees.

The source 102 may emit the light beam 104 which is collimated by the collimating lens 106. The beam 108 exiting the collimating lens 106 is incident on the test pattern 110. The ray bundles 112 carrying the object information from the test pattern 110 pass through the telecentric lens 114. The telecentric lens 114 collimates the ray bundles 112. The telecentric lens 114 further aims the ray bundles 112 at the exit pupil 116. In the depicted embodiment, the device-under-test 120 is an instance of the telecentric lens 114 inverted at 180 degrees. The device-under-test 120 focuses the ray bundles 220 onto the sensor 222, thus imaging the test pattern 110. The exit pupil 116 may be formed before the device-under-test 120 along the ray bundles 112 and within the device-under-test 120 along the ray bundles 112.

FIG. 2B shows a side view schematic diagram of light paths through the lens tester 100 and telecentric lens device-under-test 120 of FIG. 2A. Exemplary light paths of the light beam 104, the beam 108, and the ray bundles 112 are shown.

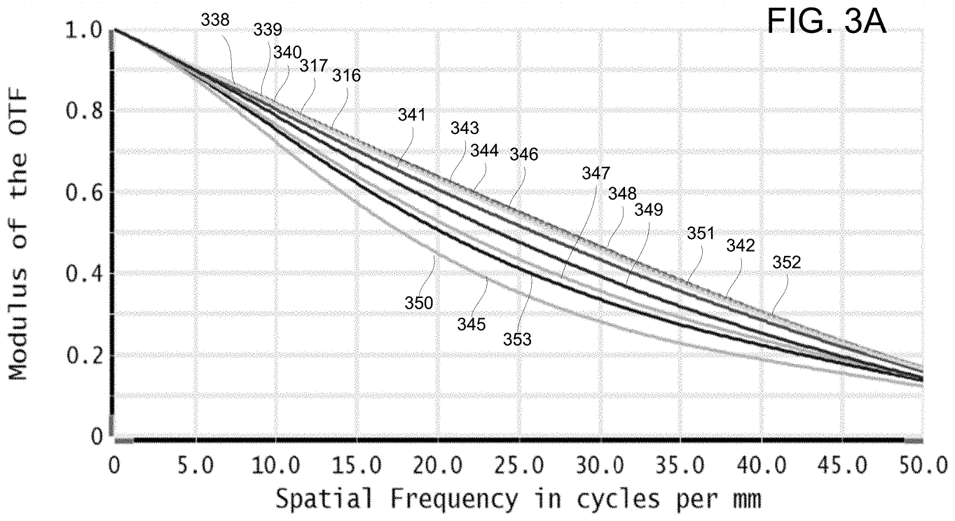

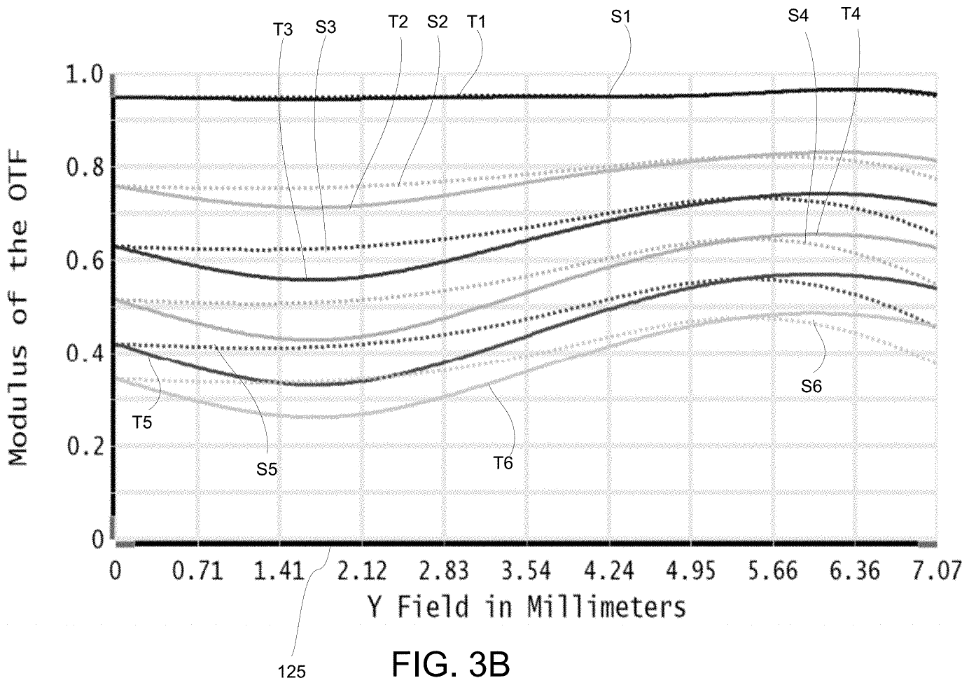

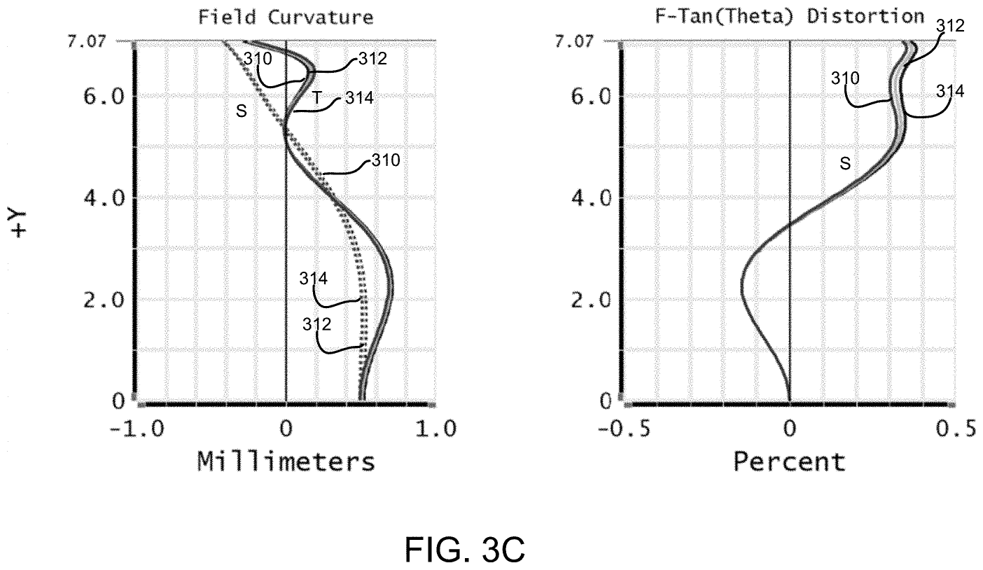

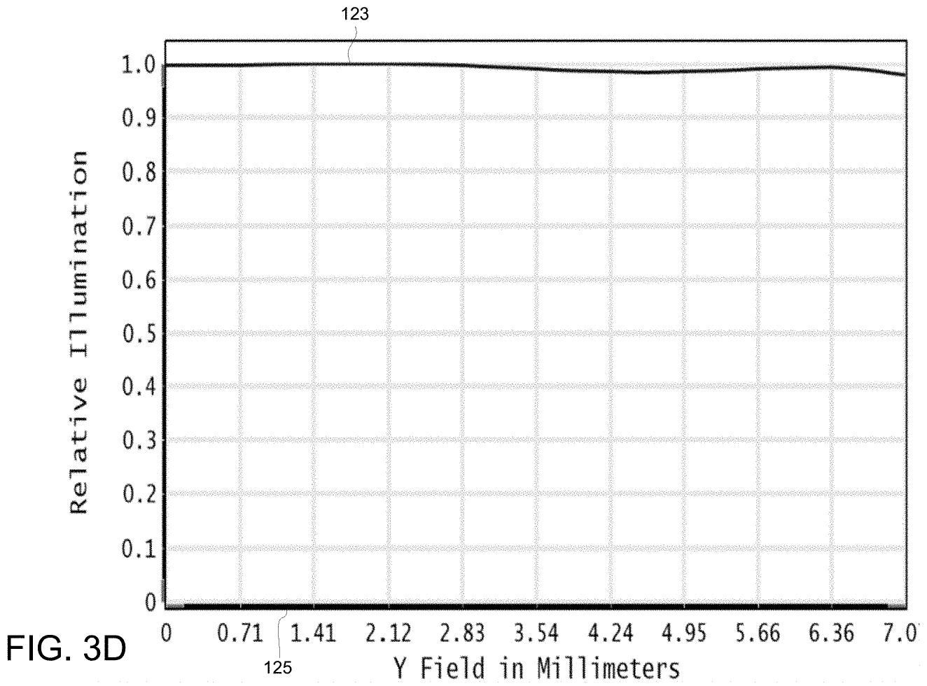

FIGS. 3A-D are the calculated values for the lens tester 100 with the device-under-test 120 illustrated in FIGS. 2A-B. FIG. 3A is a plot of MTF vs. spatial frequency, wherein the fields 125 are indicated in millimeters of object height and the diffraction limited curve is shown as well for sagittal S and tangential T planes including a S difference limit 338, a T difference limit 339, S 0.0, 3.0 mm 340, T 3.0, 3.0 mm 341, S 5.0, 0.0 mm 342, T 0.0, 5.0 mm 343, S 3.0, 5.0 mm 344, T 5.0, 3.0 mm 345, S 5.0, 3.0 mm 345, S 0.0, 0.0 mm 346, T 3.0, 0.0 mm 347, S 3.0,5.0 mm 348, T 5.0, 5.0 mm 349, T 0.0, 0.3 mm 351, S 3.0, 0.0 mm 350, S 5.0, 5.0 mm 352, and T 5.0, 0.0 353. The graph indicates that the lens tester 100 facilitates image resolution in excess of 1/2/30 nm, namely about 16 micrometers (μm).

FIG. 3B is a plot of MTF vs. field 125, where the fields 125 are indicated in millimeters (mm) of object height and the MTF components are S sagittal plane components, wherein the indices S1, S2, S3, S4, S5, S6 denote 2.5, 5, 10, 20, 25 and 30 line pairs (lp)/mm, and T tangential plane components, wherein the indices T1, T2, T3, T4, T5, T6 denote 2.5, 5, 10, 20, 25 and 30 lp/mm, respectively. FIG. 3C are plots of field curvature vs. field 125 in mm and distortion vs. field 125 in percent, showing 830 nm 310, 850 nm 312, and 870 nm 314 in the tangential plane T. 830 nm 310, 850 nm 312, and 870 nm 314 are also shown in the sagittal plane S. FIG. 3D is a plot of relative illumination 123 vs. field 125.

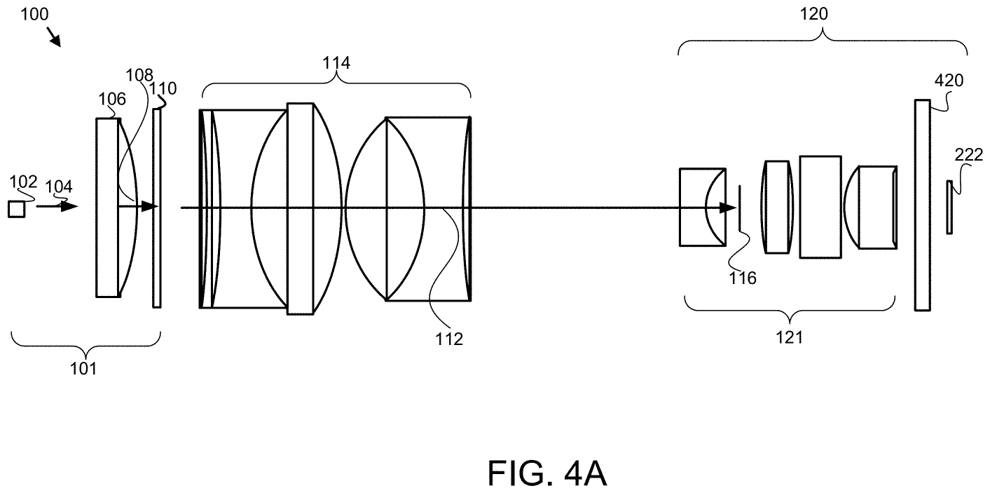

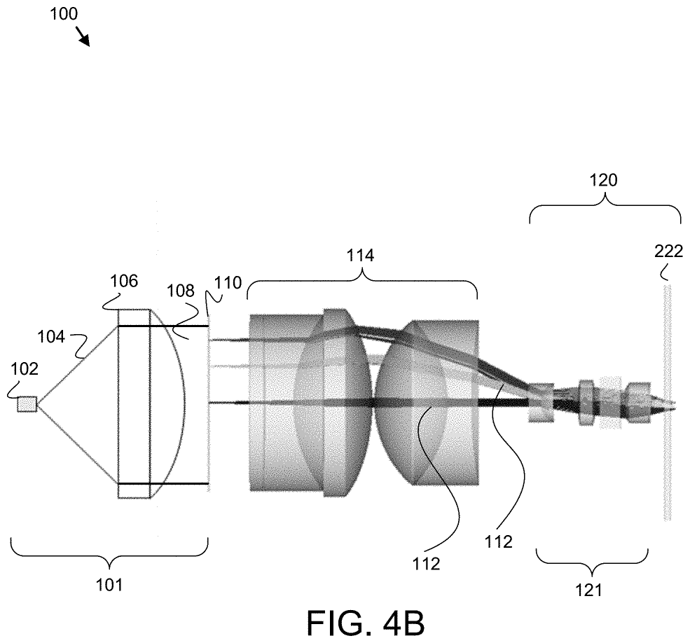

FIG. 4A is a side view schematic diagram of the lens tester 100 with a compact compound lens device-under-test 120. In the depicted embodiment, the device lens 121 is a compound lens. In addition, the sensor 222 is native to the device-under-test 120.

In one embodiment, the source 102 emits a light beam 104 which is collimated by the collimating lens 106. The beam 108 from the collimating lens 106 is incident on the test pattern 110. From the test pattern 110, ray bundles 112 carrying the object information from the test pattern 110 pass through the telecentric lens 114. The telecentric lens 114 collimates the ray bundles 112. The telecentric lens 114 further aims the ray bundles 112 on the exit pupil 116. The exit pupil 116 may coincide with the entrance pupil of the device-under-test 120, which in the depicted embodiment is located inside the device-under-test 120. The compound lens device-under-test 120 images the test pattern 110 onto the sensor 222 through a protective window 420.

FIG. 4B shows a side view schematic diagram of light paths through the lens tester 100 and the compact compound lens device-under-test 120 of FIG. 4A. Exemplary light paths of the light beam 104, the beam 108, and the ray bundles 112 are shown.

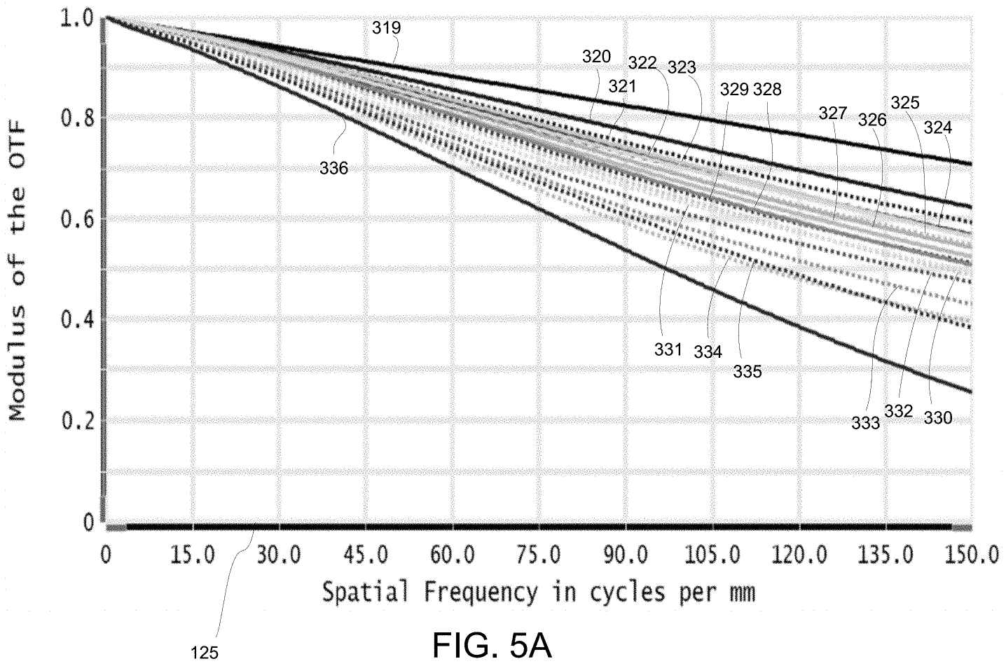

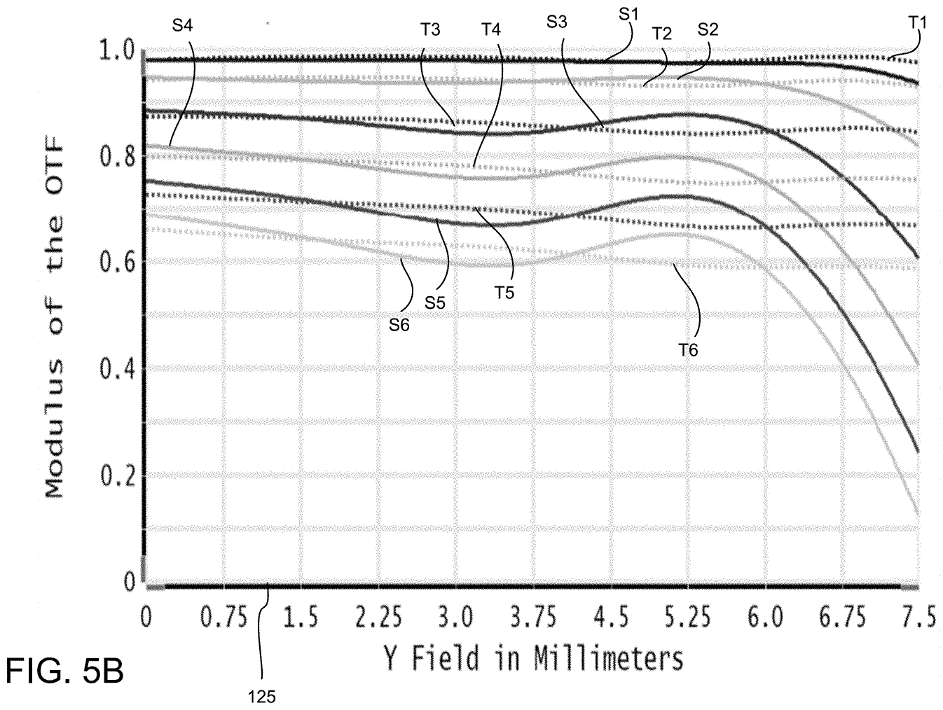

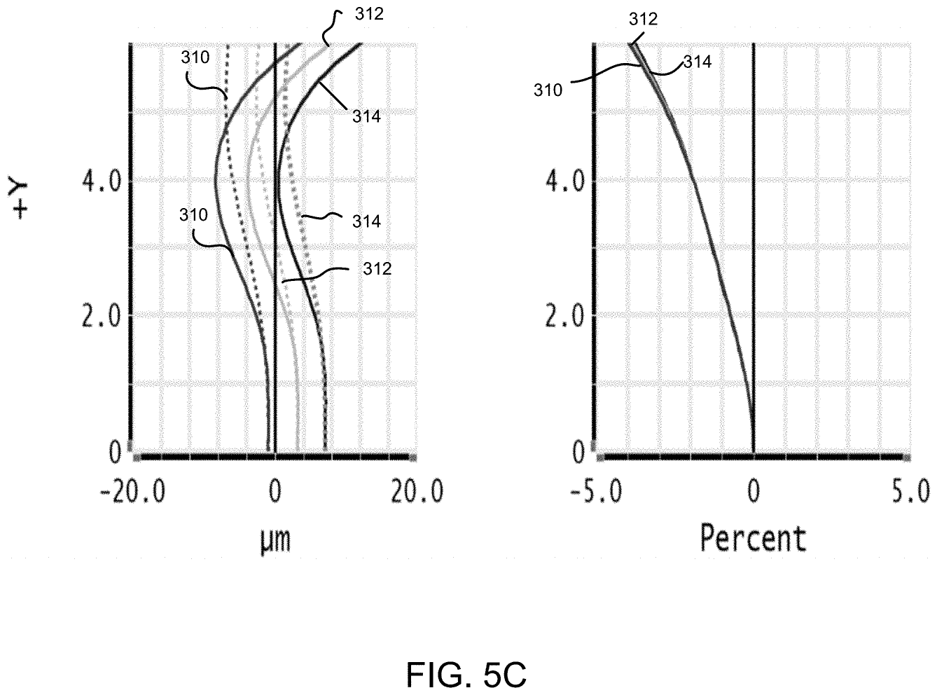

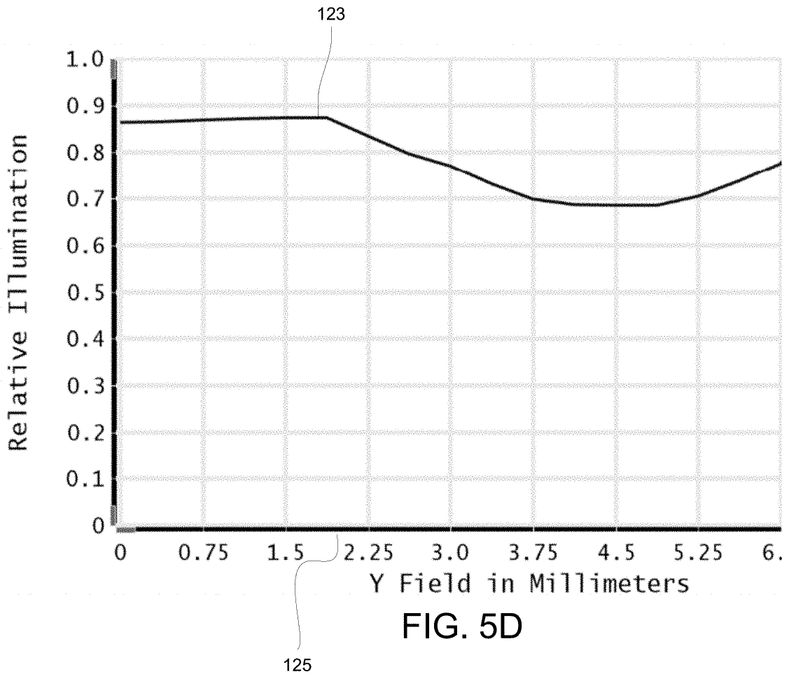

FIGS. 5A-D are the calculated values for the lens tester 100 with the compact compound lens device-under-test 120 illustrated in FIGS. 4A-B. FIG. 5A is a plot of MTF vs. spatial frequency, wherein the fields 125 are indicated in millimeters of object height and the diffraction limited curve is shown as well for sagittal S and tangential T planes for an difference limit 319, S 0.0, 0.0 mm 320, T 0-0 mm 321, S 0.0, 3.5 mm 322, T 0.0, 3.5 mm 323, S 3.0, 0.0 mm 324, T 3.0, 0.0 mm 325, S 3.0, 3.5 mm 326, T 3.0, 3.5 mm 327, S 3.0, 0 328, T 3.0, 0.0 329, S 4.5, 0.0 330, T 4.5, 0.0, 331, S 4.5, 3.5 332, T 4.5, 3.5 333, S 4.5 0.0 334, T 4.5, 0.0 335, and S 0.0, 0.0 326.

FIG. 5B is a plot of MTF vs. field 125, where the fields 125 are indicated in mm of object height are indicated in mm of object height and the MTF components are S sagittal plane components, wherein the indices S1, S2, S3, S4, S5, S6 denote 10, 25, 50, 75, 100 and 125 lp/mm respectively, and T tangential plane components, wherein the indices T1, T2, T3, T4, T5, T6 denote 10, 25, 50, 75, 100 and 125 lp/mm respectively.

FIG. 5C are plots of field curvature vs. field 125 in mm and distortion vs. field 125 in percent, showing 830 nm 310, 850 nm 312, and 870 nm 314 in the tangential plane T and the sagittal plane S.

FIG. 5D is a plot of relative illumination 123 vs. field 125.

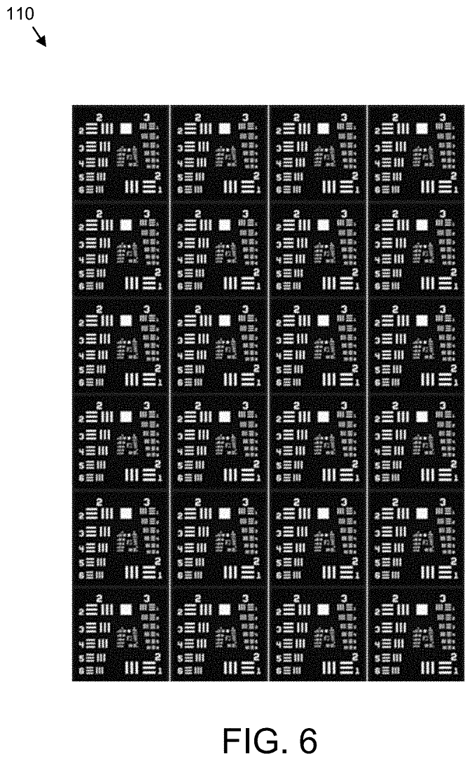

FIG. 6 illustrates a front view of a test pattern 110 with a periodic pattern based on the USAF 1951 optical test pattern. The repetitive pattern of the test pattern 110 facilitates testing a lens resolution at various field positions by a uniform object. Although the USAF 1951 optical test pattern is shown, any pattern may be employed. The test pattern 110 facilitates testing a wide variety of device-under-test 120 and/or device lenses 121.

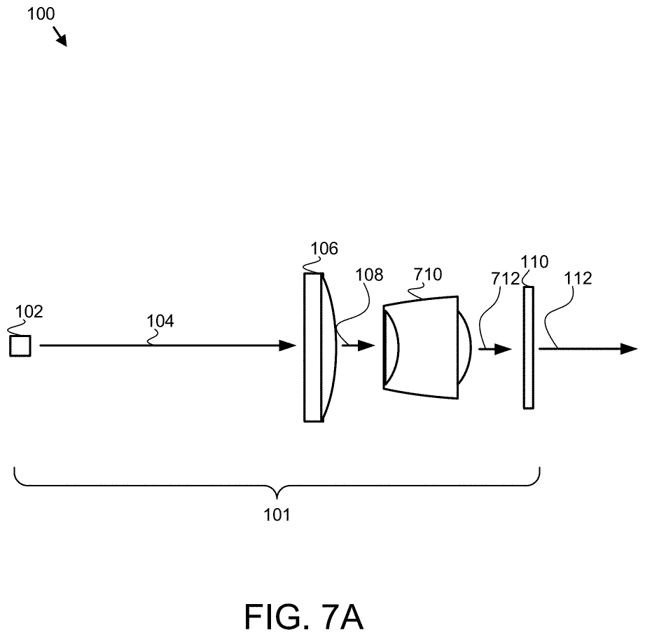

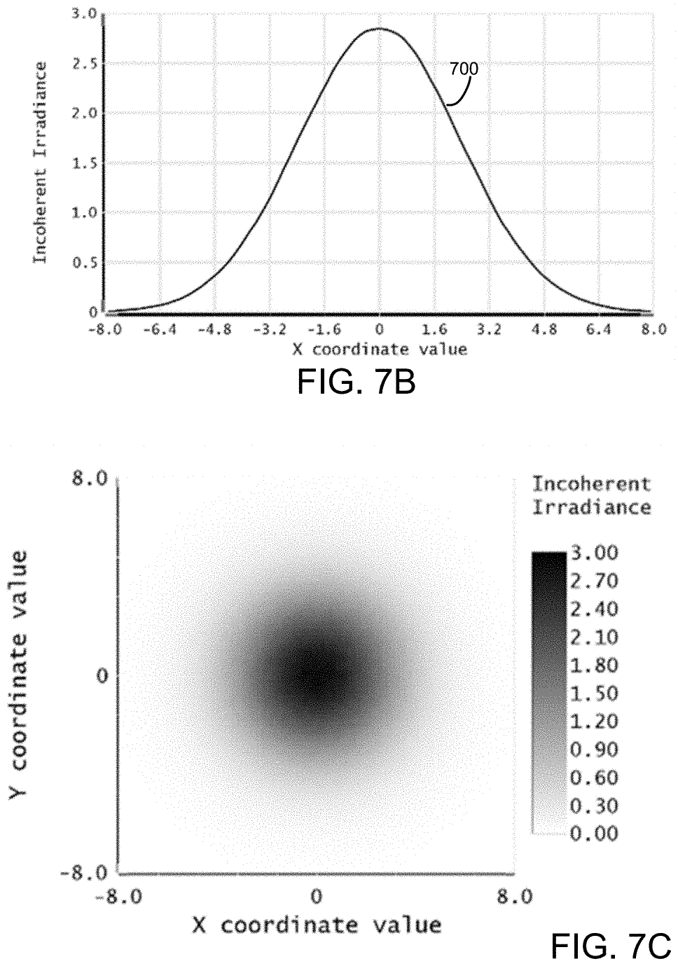

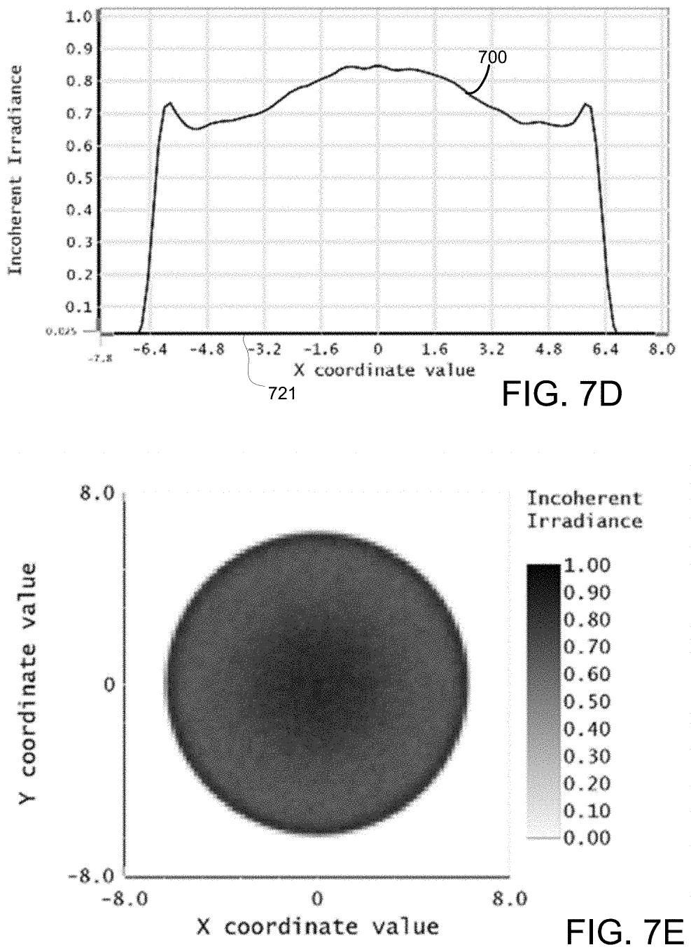

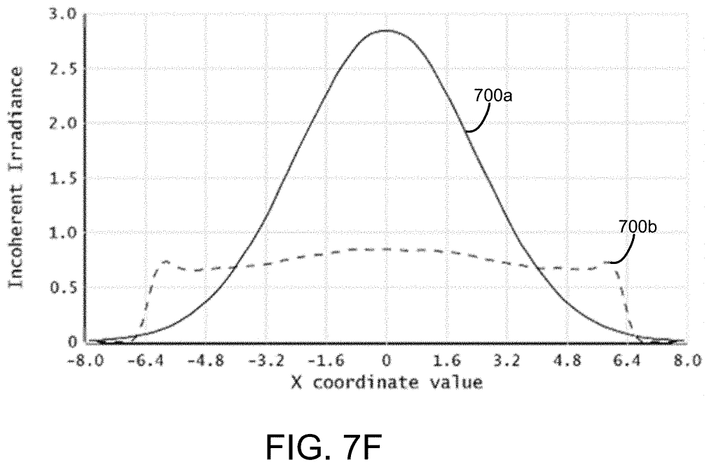

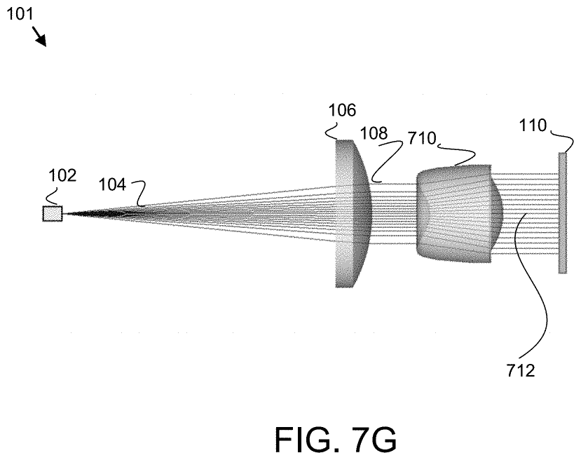

FIG. 7A is a side view schematic diagram of a light source 101 with a beam homogenizer 710. The beam homogenizer 710 may be selected from the group consisting of a single optical element, a microlens array, an engineered diffuser, and a diffractive optical element. The source 102 emits an expanding beam 104 that is then collimated by the collimator lens 106, from which a beam 108 is transmitted through the beam homogenizer 710, from which emerges a collimated and homogenized beam 712. For descriptive purposes, light traversing the lens tester 100 may be referred to as the homogenized beam 712. The homogenized beam 712 is incident on a test pattern 110 and ray bundles 112 carry the object information from the test pattern 110. In an embodiment, the source 102 emits a Gaussian beam 104 that has a Gaussian profile. The Gaussian profile remains constant over the collimator lens 106, but becomes homogenized over the beam homogenizer 710. In one embodiment, the beam homogenizer 710 is realized in a single optical element.

FIG. 7B is a plot of irradiance distribution 700 versus lateral space of calculated profiles of the beam 108 of FIG. 7A.

FIG. 7C is a plot of a footprint of irradiance distribution 700 of calculated profiles of the beam 108 of FIGS. 7A-B.

FIG. 7D is a plot of a footprint of irradiance 700 vs. lateral space 721 of calculated profiles for the homogenized beam 712 of FIG. 7A. In the shown embodiment, 90% of the power emitted from the source is transmitted into the homogenized ray bundles 112. FIG. 7E is a plot of a footprint of irradiance 700 of the calculated profiles for the homogenized beam 712 of FIG. 7A. Table 2 details one embodiment of a prescription for the beam homogenizer 710.

TABLE 2
Beam Homogenizer Prescription

| | | | | Air gap |
|---|---|---|---|---|
| Surface | 1^{st} surface | Bulk | 2^{nd} surface | to diffuser |
| Radius of | ∞ | | −18.166312 | |
| curvature (mm) | | | | |
| Index | | 1.5768 | | 1.003 |
| Abbe number | | 64.1673 | | |
| Asphere | −9.9081E−2 | | −2.2557E−2 | |
| coefficient A2 | | | | |
| Asphere | −5.5730E−4 | | −9.9633E−5 | |
| coefficient A4 | | | | |
| Asphere | 1.1852E−4 | | 4.3519E−6 | |
| coefficient A6 | | | | |
| Asphere | −3.1800E−6 | | −5.9259E−8 | |
| coefficient A8 | | | | |
| Asphere | 3.0286E−8 | | 1.1763E−9 | |
| coefficient A10 | | | | |
| Thickness (mm) | | 12.576 | | 50 |

Table 3 details one alternate embodiment of a prescription for the beam homogenizer 210.

TABLE 3
Beam Homogenizer Prescription

| | | | | Air gap |
|---|---|---|---|---|
| Surface | 1^{st} surface | Bulk | 2^{nd} surface | to diffuser |
| Radius of | ∞ | | −18.0 to | |
| curvature (mm) | | | −18.3 | |
| Index | | 1.50 to | | 1.003 |
| | | 1.65 | | |
| Abbe number | | 63.5-64.5 | | |
| Asphere | −9.90E−2 to | | −2.25E−2 to | |
| coefficient A2 | −9.91E−2 | | −2.265E−2 | |
| Asphere | −5.50E−4 to | | −9.90E−5 to | |
| coefficient A4 | −5.65E−4 | | −10.05E−5 | |
| Asphere | 1.10E−4 to | | 4.30−6 to | |
| coefficient A6 | 1.25E−4 | | 4.40E−6 | |
| Asphere | −3.10E−6 to | | −5.85E−8 to | |
| coefficient A8 | −3.25E−6 | | −6.00E−8 | |
| Asphere | 3.00E−8 to | | 1.10E−9 to | |
| coefficient A10 | 3.05E−8 | | 1.25E−9 | |
| Thickness (mm) | | 12.0 to | | 47 to |
| | | 13.0 | | 53 |

FIG. 7F is a plot of footprints of irradiance distribution 700 of calculated profiles for the beam 108 and the homogenized beam 712. The irradiance distribution 700a of the beam 108 is superimposed on the irradiance distribution 700b of the homogenized beam 712. In one embodiment, at least 90 percent of the optical power is transmitted through the beam homogenizer 710.

FIG. 7G is a side view schematic diagram of light paths through a light source 102 with beam homogenizer 710. The light paths include the light beam 104, beam 108, and homogenized beam 712.

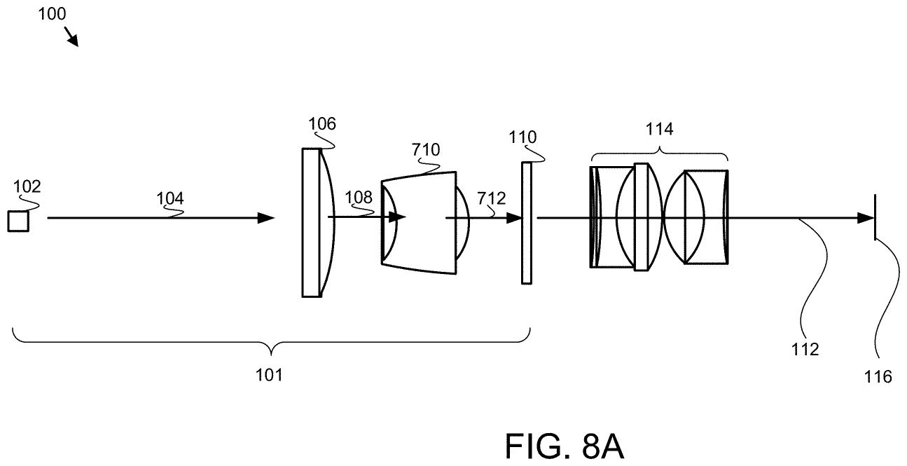

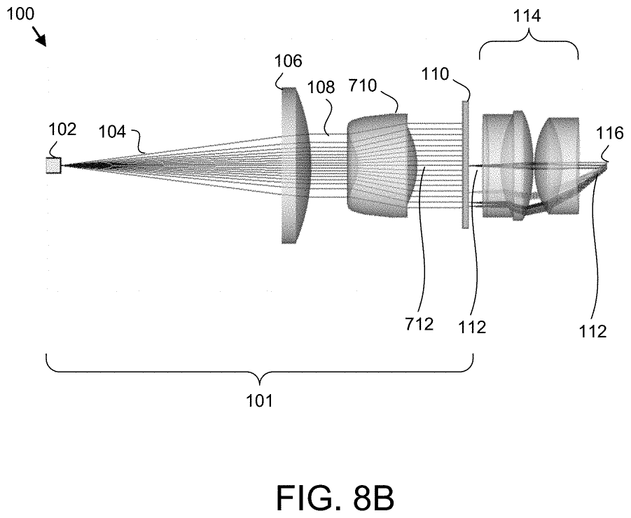

FIG. 8A is a side view schematic diagram of the lens tester 100 illuminated by a light source 101 with a beam homogenizer 710. The source 102 emits an expanding beam 104 that is then collimated by a collimating lens 106. The beam 108 is transmitted through a beam homogenizer 710, from which emerges as a collimated and homogenized beam 712, becoming incident on the test pattern 110. The ray bundles 116 carrying the object information of the test pattern 110 pass through the telecentric lens 114 that collimates the ray bundles 112, aiming the ray bundles 112 at the exit pupil 116. Since the lens 114 is telecentric, the distance from the test pattern 110 has a very large tolerance without compromising the lens tester performance.

FIG. 8B shows a side view schematic diagram of light paths through the lens tester 100 with beam homogenizer 710 of FIG. 8A. The light paths include the collimated light beam 104, collimated beam 108, homogenized beam 712, and ray bundles 112.

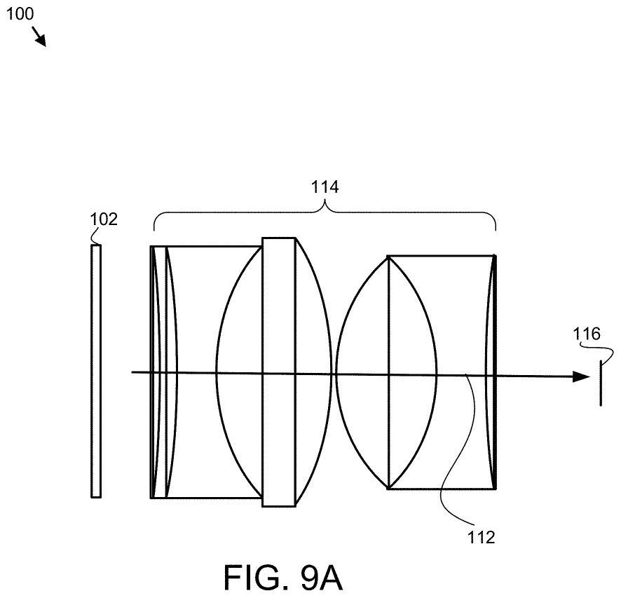

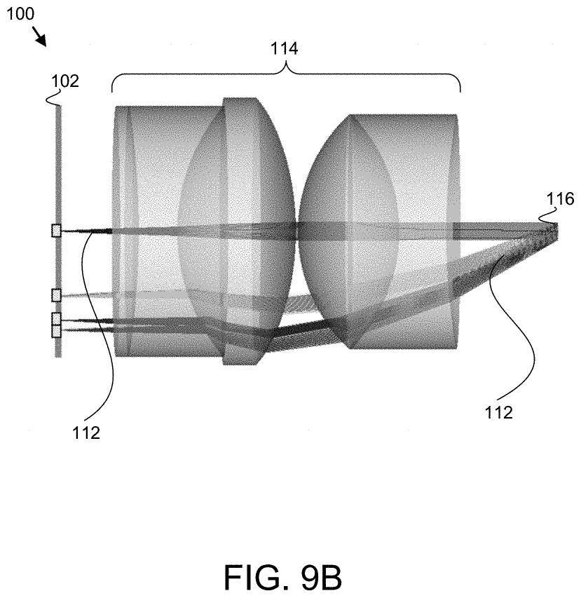

FIG. 9A is a side view schematic of a lens tester 100 without a test pattern 110. In the depicted embodiment, the lens tester 100 includes sources 102 and a telecentric lens 114. The sources 102 may comprise a plurality of light sources 102 such as multiple Light Emitting Diodes (LED), laser diodes, vertically emitting semiconductor lasers and/or the like. The sources 102 emit the ray bundles 112 that pass through and are refracted by the telecentric lens 114. The telecentric lens 114 collimates the ray bundles 112 and focuses the ray bundles 112 at the exit pupil 116. Since the telecentric lens 114 is telecentric, the distance from the sources 102 have a very large tolerance without compromising the lens tester performance.

FIG. 9B is a side view schematic of light paths through a lens tester 100 without a test pattern 110 of FIG. 9A. The light paths include the ray bundles 112.

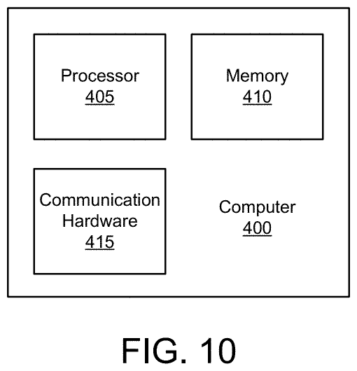

FIG. 10 is a schematic block diagram of a computer 400. In the depicted embodiment, the computer 400 includes a processor 405, memory 410, and communication hardware 415. The memory 410 may store code. The processor 405 may execute the code. The communication hardware 415 communicates with other devices such as the sensor 222.

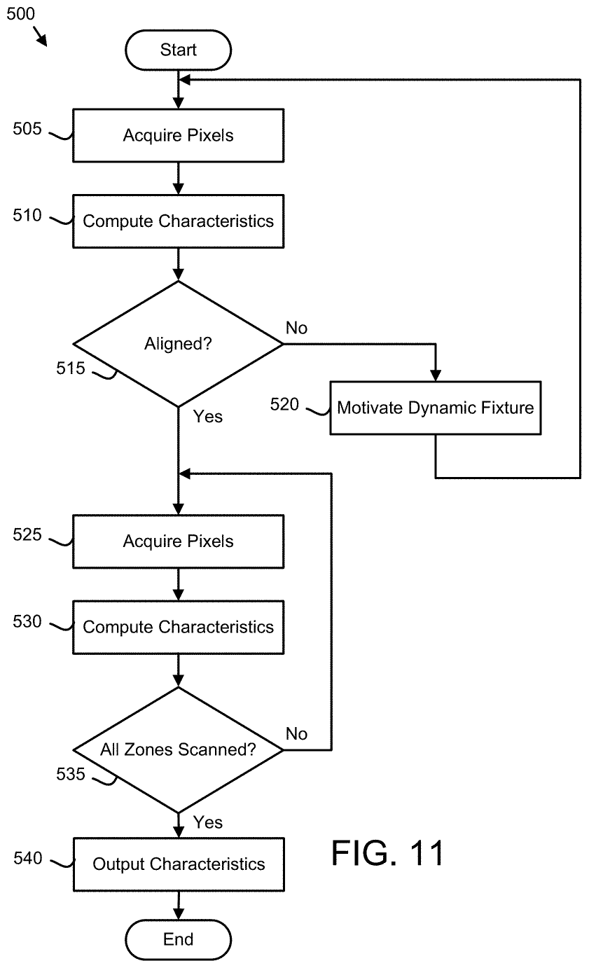

FIG. 11 is a flow chart diagram of a method 500 of computation of the device-under-test characteristics. The method 500 may compute the characteristics of the device-under-test 120. The method 500 may be performed by the lens tester 100, the sensor 222, and/or the computer 400.

The method 500 starts, and in one embodiment, the sensor 222 acquires 505 pixel charge contents on which photons corresponding to an image pattern of the test pattern 110 are converted to electrons. The telecentric lens 114 together with the device-under-test 120 form an image from light emitted by the light source 101. In a certain embodiment, the image is of the test pattern 110 shown in FIG. 6. The processor 405 may receive the pixel charge contents from the image of the test pattern 110 as binary data and using one or more algorithms compute 510 the device-under-test characteristics. The processor 405 may further determine 515 if the device-under-test 120 and/or the sensor 222 are aligned relative to the lens tester 100. If the device-under-test 120 and/or sensor 222 are not aligned, the processor 405 may motivate 520 the dynamic fixture 130 to better align the device-under-test 120 and/or sensor 222. After motivating the dynamic fixture 130, the sensor 222 further acquires 505 additional pixel charge contents.

If the device-under-test 120 and sensor 222 are aligned with the lens tester 100, the sensor 222 may acquire 525 pixel charge contents as described in step 505. The processor 405 may receive the pixel charge contents of the image representation of the test pattern 110 and using one or more algorithms compute 530 the device-under-test characteristics. In one embodiment, the processor 405 computes 530 the device-under-test characteristics sequentially for a given zone of the field-of-view of the telecentric lens 114 and/or the sensor 220. The device-under-test characteristics may include but are not limited to MTF, relative illumination (RI), and distortion of the image for a given zone. The lens tester 100 may continue acquiring 525 pixel charge contents and computing 530 characteristics until determining 535 that all the zones have been scanned. If all the zones have been scanned, the lens tester 100 may output 540 the characteristics and the method 500 ends. The characteristics may be output by being displayed. In an embodiment, the computed characteristic value are transmitted electronically to another electronic device, such as another computer 400.

Problem/Solution

Testers for optical devices are often bulky and expensive. The embodiments employ a telecentric lens 114 to focus light on the exit pupil 116 disposed relative to the device lens 121 of the device-under-test 120. The telecentric lens 114 supports of large tolerance in the distance from the test pattern 110 to the device lens 121 and/or sensor 222. As a result, the size and cost of the lens tester 100 is reduced. In addition, the use of the telecentric lens 114 allows the lens tester 100 to be easily scaled for a plurality of optical device sizes and focal lengths.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus comprising:
a light source;
a telecentric lens that aims light from the light source on an exit pupil formed relative to a device lens of a device-under-test; and
a sensor that receives light from the device-under-test.

2. The apparatus of claim 1, the apparatus further comprising:
a collimating lens that collimates light from the light source; and
a test pattern, wherein the collimated light is incident on the test pattern for testing the spatial resolution of the device lens, wherein the telecentric lens aims ray bundles from the test pattern on the exit pupil.

3. The apparatus of claim 2, wherein the test pattern is an optical diffuser with a diffuser angle of expansion of less than ±10 degrees.

4. The apparatus of claim 2, the apparatus further comprising a beam homogenizer that homogenizes the light of the light source incident on the test pattern, wherein the beam homogenizer is selected from the group consisting of a single optical element, a microlens array, an engineered diffuser, and a diffractive optical element.

5. The apparatus of claims 4, wherein the beam homogenizer has the following prescription:

| | | | | Air gap |
|---|---|---|---|---|
| Surface | 1^{st} surface | Bulk | 2^{nd} surface | to diffuser |
| Radius of | ∞ | | −18.0 to | |
| curvature (mm) | | | −18.3 | |
| Index | | 1.50 to | | 1.003 |
| | | 1.65 | | |
| Abbe number | | 63.5-64.5 | | |
| Asphere | −9.90E−2 to | | −2.25E−2 to | |
| coefficient A2 | −9.91E−2 | | −2.265E−2 | |
| Asphere | −5.50E−4 to | | −9.90E−5 to | |
| coefficient A4 | −5.65E−4 | | −10.05E−5 | |
| Asphere | 1.10E−4 to | | 4.30−6 to | |
| coefficient A6 | 1.25E−4 | | 4.40E−6 | |
| Asphere | −3.10E−6 to | | −5.85E−8 to | |
| coefficient A8 | −3.25E−6 | | −6.00E−8 | |
| Asphere | 3.00E−8 to | | 1.10E−9 to | |
| coefficient A10 | 3.05E−8 | | 1.25E−9 | |
| Thickness (mm) | | 12.0 to | | 47 to |
| | | 13.0 | | 53 |

6. The apparatus of claim 1, wherein the telecentric lens has the following prescription:

| | Power | | Abbe | Thickness | Aperture |
|---|---|---|---|---|---|
| Element | (diopter) | Index | number | (mm) | (mm) |
| Diffuser | 0 | NA | NA | NA | 17.0 |
| Air gap | 0 | 1.0003 | NA | 3.768 | |
| Primary | −75.1665 | 1.63148 | 60.102 | 1.5 | 17.0 |
| Secondary | 45.02007 | 1.59099 | 38.03 | 2.64 | 19.4 |
| Air | | 1.0003 | | 3.57 | |
| Tertiary | 97.5723 | 1.99543 | 29.06 | 5.012 | 19.4 |
| Air | | 1.0003 | | 0.15 | |
| Quaternary | 129.0201 | 1.63148 | 60.102 | 6.875 | 16.0 |
| Quinary | −71.4844 | 1.68134 | 30.068 | 3.62 | 16.0 |
| Air | | 1.0003 | | 7.46 | |
| Stop | 0 | NA | NA | | 1.11 |

7. The apparatus of claim 1, wherein the light source comprises a source selected from the group consisting of a point source, an extended source, and a plurality of light sources.

8. The apparatus of claim 1, wherein the light source emits one of polychromatic radiation and monochromatic radiation.

9. The apparatus of claim 1, wherein the light source emits light in a specified frequency in the group consisting of 190-390 nanometers (nm), 390-780 nm, and above 780 nm.

10. The apparatus of claim 1, wherein the exit pupil is formed outside of the telecentric lens.

11. The apparatus of claim 1, the apparatus further comprising a processor that computes the characteristics of the device-under-test, wherein the characteristics comprise at least one of Modulus of Optical Transfer Function (MTF), relative illumination, and distortion.

12. The apparatus of claim 1, the apparatus further comprising a dynamic fixture that actively aligns the at least one of the device-under-test and the sensor based on characteristics of the ray bundles.

13. The apparatus of claim 1, wherein the telecentric lens collimates a beam from the light source.

14. The apparatus of claim 1, wherein the sensor is native to the device-under-test.

15. A system comprising:
a light source;
a telecentric lens that aims light from the light source on an exit pupil forms relative to a device lens of a device-under-test;
a sensor that receives light from the device-under-test; and
a dynamic fixture that actively aligns at least one of the device-under-test and the sensor.

16. The system of claim 15, the system further comprising:
a collimating lens that collimates light from the light source; and
a test pattern, wherein the collimated light is incident on the test pattern for testing the spatial resolution of the device lens, wherein the telecentric lens aims ray bundles from the test pattern on the exit pupil.

17. The system of claim 16, wherein the exit pupil coincides an entrance pupil of the device-under-test.

18. The system of claim 16, wherein the test pattern comprises an optical diffuser with a diffuser angle of expansion of less than ±10 degrees.

19. A method comprising:
acquiring pixel charge contents of an image pattern from a sensor that receives light from a device-under-test, wherein the light is aimed from a light source on an exit pupil formed relative to a device lens of the device-under-test by a telecentric lens; and
computing device-under-test characteristics from the pixel charge contents.

20. The method of claim 19, wherein the light from the light source is collimated light, the collimated light is incident on a test pattern for testing the spatial resolution of the device lens, and the telecentric lens aims ray bundles from the test pattern on the exit pupil.
